(19) United States
(12) Patent Application Publication
(10) Pub. No.: US 2014/0285402 A1
(43) Pub. Date: Sep. 25, 2014

(54) SOCIAL DATA-AWARE WEARABLE DISPLAY SYSTEM

(71) Applicants: Hosain Sadequr Rahman, San Francisco, CA (US); Hari N. Chakravarthula, San Jose, CA (US)

(72) Inventors: Hosain Sadequr Rahman, San Francisco, CA (US); Hari N. Chakravarthula, San Jose, CA (US)

(73) Assignee: AliphCom, San Francisco, CA (US)

(21) Appl. No.: 14/205,151

(22) Filed: Mar. 11, 2014

Related U.S. Application Data
(60) Provisional application No. 61/780,892, filed on Mar. 13, 2013.

(51) Int. Cl. G02B 27/01

(52) U.S. Cl. CPC G02B 27/017; G02B 2027/0178
USPC 345/8

(57) ABSTRACT

Techniques associated with a social data-aware wearable display system are described, including a frame configured to be worn, a display coupled to the frame, the display configured to provide an image in a field of vision, a sensor configured to capture sensor data, a secondary sensor configured to capture environmental data, a sensor analytics module configured to process the sensor data and the environmental data to generate sensor analytics data, and a communication facility configured to send sensor analytics data to another device and to receive remote data. Some embodiments also include an adaptive optics module configured to determine an optical distortion to be applied to the image.

### CROSS-REFERENCE TO RELATED APPLICATIONS

This application claims the benefit of U.S. Provisional Patent Application No. 61/780,892 (Attorney Docket No. ALI-159P), filed Mar. 13, 2013, which is incorporated by reference herein in its entirety for all purposes.

### FIELD

The present invention relates generally to electrical and electronic hardware, electromechanical and computing devices. More specifically, techniques related to a social data-aware wearable display system are described.

### BACKGROUND

Conventional techniques for accessing social data are limited in a number of ways. Conventional techniques for accessing social data, including information about persons and entities in a user's social network, typically use applications on devices that are stationary (i.e., desktop computer) or mobile (i.e., laptop or mobile computing device). Such conventional techniques typically are not well-suited for hands-free access to social data, as they typically require one or more of typing, holding a device, pushing buttons, or otherwise navigating a touchscreen, keyboard or keypad.

Conventional wearable devices also often are not hands-free, and even wearable display devices that are hands-free typically are not equipped to access social data automatically, and particularly in context (i.e., pertaining to a user's behavior, location and environment).

Thus, what is needed is a solution for a social data-aware wearable display system without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an exemplary social data-aware wearable display system;

FIG. 2 illustrates an exemplary wearable display device;

FIG. 3 illustrates another exemplary wearable display device;

FIG. 4A illustrates an exemplary wearable display device with adaptive optics;

FIG. 4B-4C illustrate side views of an exemplary wearable display device with adaptive optics;

FIG. 4D depicts a diagram of an adaptive optics system;

FIG. 5 depicts an exemplary computer system 500 suitable for use in the systems, methods, and apparatus described herein that include wearable display device 100;

FIG. 6A depicts an exemplary wearable display device having a set of sensors in an environment including objects; and

FIG. 6B depicts a side-view of an exemplary wearable display device having a sensor analytics module.

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, an apparatus, a device, and a method associated with a wearable device structure with enhanced detection by motion sensor. In some embodiments, motion may be detected using an accelerometer that responds to an applied force and produces an output signal representative of the acceleration (and hence in some cases a velocity or displacement) produced by the force. Embodiments may be used to couple or secure a wearable device onto a body part. Techniques described are directed to systems, apparatuses, devices, and methods for using accelerometers, or other devices capable of detecting motion, to detect the motion of an element or part of an overall system. In some examples, the described techniques may be used to accurately and reliably detect the motion of a part of the human body or an element of another complex system. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

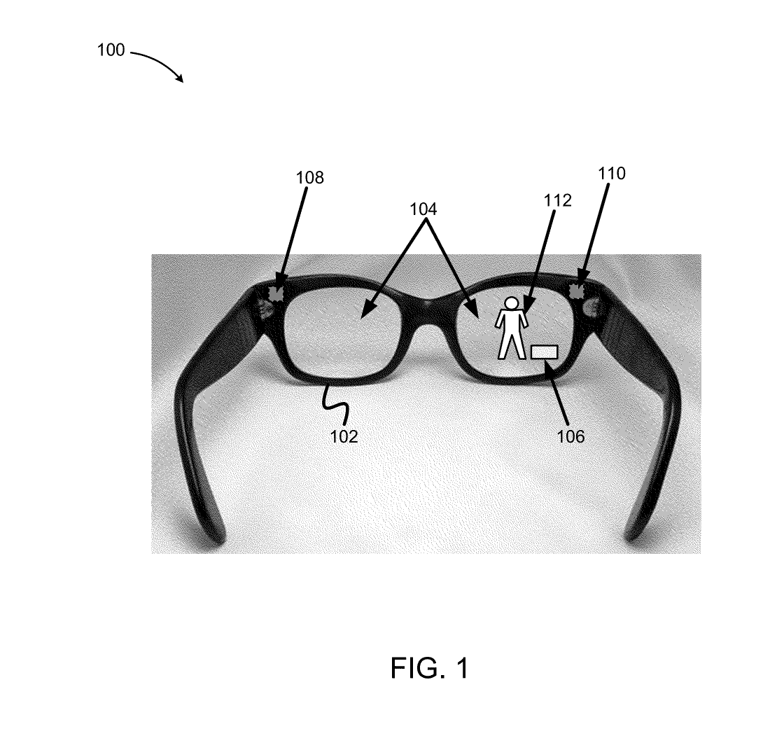

FIG. 1 illustrates an exemplary wearable display device. Here, wearable device 100 includes frame 102, lenses 104, display 106, and sensors 108-110. In some examples, an object may be seen through lenses 104 (e.g., person 112). In some examples, frame 102 may be implemented similarly to a pair of glasses. For example, frame 102 may be configured to house lenses 104, which may be non-prescription or prescription lenses. In some examples, frame 102 may be configured to be worn on a face (e.g., over a bridge of a nose, over a pair of ears, or the like) such that a user may be able to see through lenses 104. In some examples, frame 102 may include sensors 108-110. In some examples, one or more of sensors 108-110 may be configured to capture visual (e.g., image, video, or the like) data. For example, one or more of sensors 108-110 may include a camera, light sensor, or the like, without limitation. In other examples, one or more of sensors 108-110 also may be configured to capture audio data or other sensor data (e.g., temperature, location, light, or the like). For example, one or more of sensors 108-110 may include a microphone, vibration sensor, or the like, without limitation. In some examples, one or more of sensors 108-110, or sensors disposed elsewhere on frame 102 (not shown), may be configured to capture secondary sensor data (e.g., environmental, location, movement, or the like). In some examples, one or more of sensors 108-110 may be disposed in different locations on frame 102 than shown, or coupled to a different part of frame 102, for capturing sensor data associated with a different direction or location relative to frame 102.

In some examples, display 106 may be disposed anywhere in a field of vision (i.e., field of view) of an eye. In some examples, display 106 may be disposed on one or both of lenses 104. In other examples, display 106 may be implemented independently of lenses 104. In some examples, display 106 may be disposed in an unobtrusive portion of said field of vision. For example, display 106 may be disposed on a peripheral portion of lenses 104, such as near a corner of one or both of lenses 104. In other examples, display 106 may be implemented unobtrusively, for example by operating in two or more modes, where display 106 is disabled in one mode and enabled in another mode. In some examples, in a disabled mode, or even in a display-enabled mode when there is no data to display (i.e., a non-display mode), display 106 may be configured to act similar to or provide a same function as lenses 104 (i.e., prescription lens or non-prescription lens). For example, in a non-display mode, display 106 may mimic a portion of a clear lens where lenses 104 are clear. In another example, in a non-display mode, display 106 may mimic a portion of a prescription lens having a prescription similar, or identical, to lenses 104. In still another example, in either a display or non-display mode, display 106 may have other characteristics in common with lenses 104 (e.g., UV protection, tinting, coloring, and the like). In some examples, when there is social data (i.e., generated and received from another device, as described herein) to present in display 106, information may appear temporarily, and then disappear after a predetermined period of time (i.e., for a length of time long enough to be read or recognized by a user). In some examples, display 106 may be implemented using transmissive display technology (e.g., liquid crystal display (LCD) type, or the like). In other examples, display 106 may be implemented using reflective, or projection, display technology (e.g., liquid crystal on silicon (LCoS)/pico type, or the like), for example, with an electrically controlled reflective material in a backplane. In other examples, the quantity, type, function, structure, and configuration of the elements shown may be varied and are not limited to the examples provided.

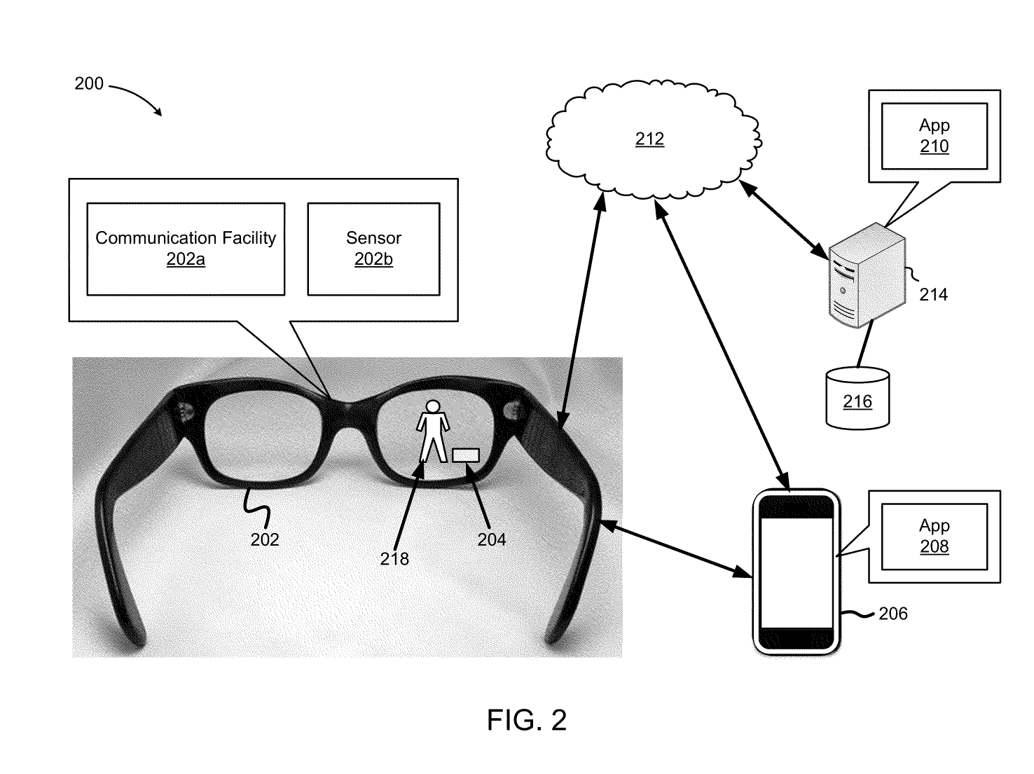

FIG. 2 illustrates an exemplary social data-aware wearable display system. Here, system 200 includes wearable device 202, including display 204, mobile device 206, applications 208-210, network 212, server 214 and storage 216. Like-numbered and named elements may describe the same or substantially similar elements as those shown in other descriptions. In some examples, wearable device may include communication facility 202a and sensor 202b. In some examples, sensor 202b may be implemented as one or more sensors configured to capture sensor data, as described herein. In some examples, communication facility 202a may be configured to exchange data with mobile device 206 and network 212 (i.e., server 214 using network 212), for example using a short-range communication protocol (e.g., Bluetooth®, NFC, ultra wideband, or the like) or longer-range communication protocol (e.g., satellite, mobile broadband, GPS, WiFi, and the like). As used herein, “facility” refers to any, some, or all of the features and structures that are used to implement a given set of functions. In some examples, mobile device 206 may be implemented as a mobile communication device, mobile computing device, tablet computer, or the like, without limitation. In some examples, wearable device 202 may be configured to capture sensor data (i.e., using sensor 202b) associated with an object (e.g., person 218) seen by a user while wearing wearable device 202. For example, wearable device 202 may capture visual data associated with person 218 when a user wearing wearable device 202 sees person 218. In some examples, wearable device 202 may be configured to send said visual data to mobile device 206 or server 214 for processing by application 208 and/or application 210, as described herein. In some examples, mobile device 206 also may be implemented with a secondary sensor (not shown) configured to capture secondary sensor data (e.g., movement, location (i.e., using GPS), or the like).

In some examples, mobile device 206 may be configured to run or implement application 208, or other various applications. In some examples, server 214 may be configured to run or implement application 210, or other various applications. In other examples, applications 208-210 may be implemented in a distributed manner using both mobile device 206 and server 214. In some examples, one or both of applications 208-210 may be configured to process sensor data received from wearable device 202, and to generate pertinent social data (i.e., social data relevant to sensor data captured by wearable device 202, and thus relevant to a user's environment) using the sensor data for presentation on display 204. As used herein, “social data” may refer to data associated with a social network or social graph, for example, associated with a user. In some examples, social data may be associated with a social network account (e.g., Facebook®, Twitter®, LinkedIn®, Instagram®, Google+®, or the like). In some examples, social data also may be associated with other databases configured to store social data (e.g., contacts lists and information, calendar data associated with a user's contacts, or the like). In some examples, application 208 may be configured to derive characteristic data from sensor data captured using wearable device 202. For example, wearable device 202 may be configured to capture visual data associated with one or more objects (e.g., person 218, or the like) able to be seen or viewed using wearable device 202, and application 208 may be configured to derive a face outline, facial features, a gait, motion signature (i.e., motion fingerprint), or other characteristics, associated with said one or more objects. In some examples, application 210 may be configured to run various algorithms using sensor data, including secondary sensor data, captured by wearable device 202 in order to generate (i.e., gather, obtain or determine by querying and cross-referencing with a database) pertinent social data associated with said sensor data. In some examples, application 210 also may be configured to run one or more algorithms on secondary sensor data and derived data from mobile device 206 in order to generate pertinent social data associated with said sensor data. In some examples, said algorithms may include a facial recognition algorithm, a social database mining algorithm, an intelligent contextual information provisioning algorithm (i.e., to enable mobile device 206 and/or wearable device 202 to provide data or services in response, or otherwise react, to sensor, social, and environmental data), or the like. In some examples, one or both of applications 208-210 also may be configured to format or otherwise process data (i.e., pertinent social data) to be presented, for example, using display 204.

In some examples, pertinent social data may be gathered from social networking databases, or other databases configured to store social data, as described herein. In some examples, pertinent social data may include identity data associated with an identity, for example, of a member of a social network. In some examples, identity data may reference or describe a name and other identifying information (e.g., a telephone number, an e-mail address, a physical address, a relationship (i.e., with a user of the social network to which said member belongs), an unique identification (e.g., a handle, a username, a social security number, a password, or the like), and the like) associated with an identity. In some examples, applications 208-210 may be configured to obtain identity data associated with sensor data, for example, associated with an image or video of person 218, and to provide said identity data to wearable device 202 to present using display 204. In some examples, pertinent social data generated by also may reference or describe an event or other social information (e.g., a birthday, a graduation, another type of milestone, a favorite food, a frequented venue (e.g., restaurant, café, shop, store, or the like) nearby, a relationship to a user (e.g., friend of a friend, co-worker, boss's daughter, or the like), a relationship status, or the like) relevant to a member of a social network identified using sensor data. In other examples, the quantity, type, function, structure, and configuration of the elements shown may be varied and are not limited to the examples provided.

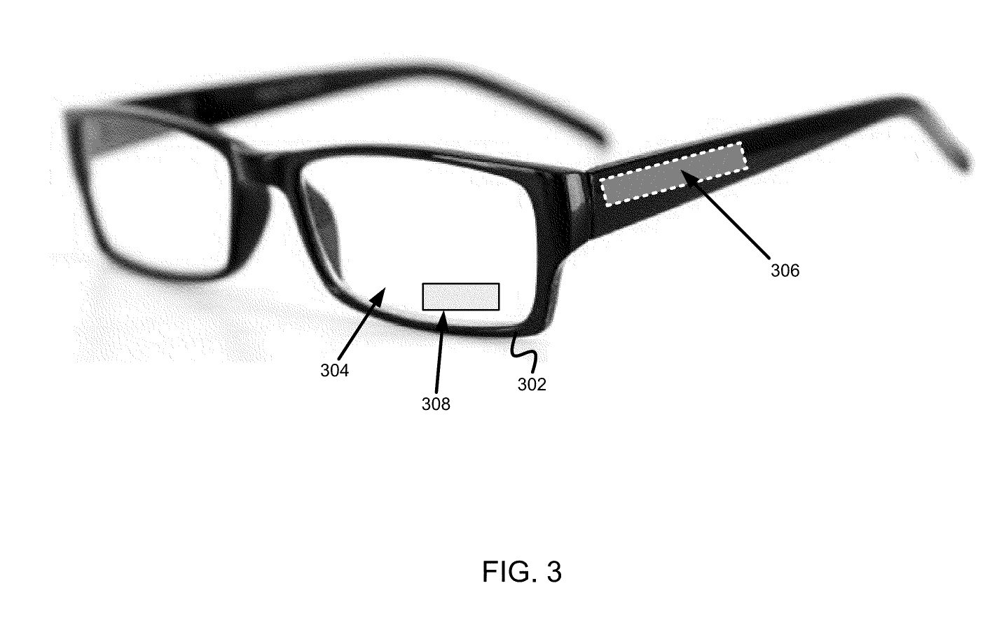

FIG. 3 illustrates another exemplary wearable display device. Here, wearable device 302 includes viewing area 304 and focus feature 306. Like-numbered and named elements may describe the same or substantially similar elements as those shown in other descriptions. In some examples, viewing area 304 may include display 308, which may be disposed on some or all of viewing area 304. In some examples, display 308 may be dynamically focused using focus feature 306, for example, implemented in a frame arm of wearable device 302, to adapt to a user's eye focal length such that information and images (e.g., graphics, text, various types of light, patterns, or the like) presented on display 308 appear focused to a user. In some examples, focus feature 306 may be implemented with a sensor (or an array of sensors) to detect a touching motion (e.g., a tap of a finger, a sliding of a finger, or the like). In some examples, focus feature 306 may be configured to translate said touching motion into a focal change implemented on display 308, for example, using software configured to adjust display 308 or optically moving lens surface with respect to each other (i.e., laterally or vertically). In other examples, a camera (not shown), either visual or infrared (IR) or other type, may be implemented facing a user and configured to sense one or more parameters associated with a user's eye (e.g., pupil opening size, or the like). Said one or more parameters may be used by wearable device 308 to automatically focus information or images presented on display 308. In still other examples, the quantity, type, function, structure, and configuration of the elements shown may be varied and are not limited to the examples provided.

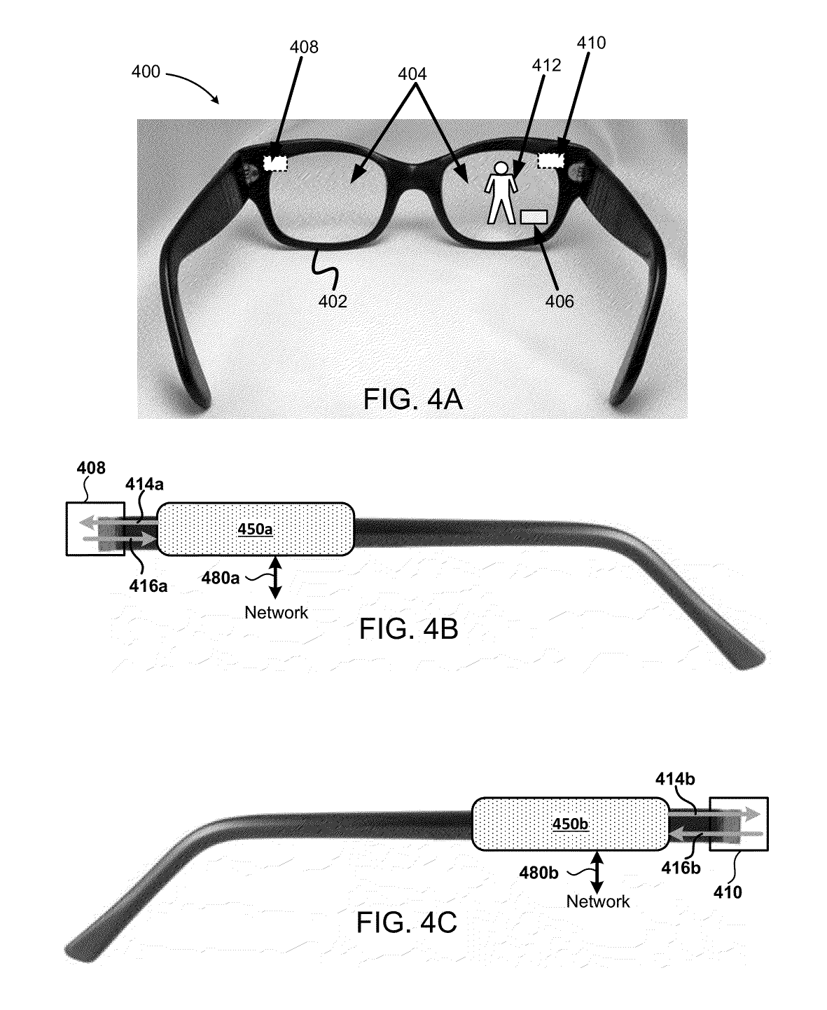

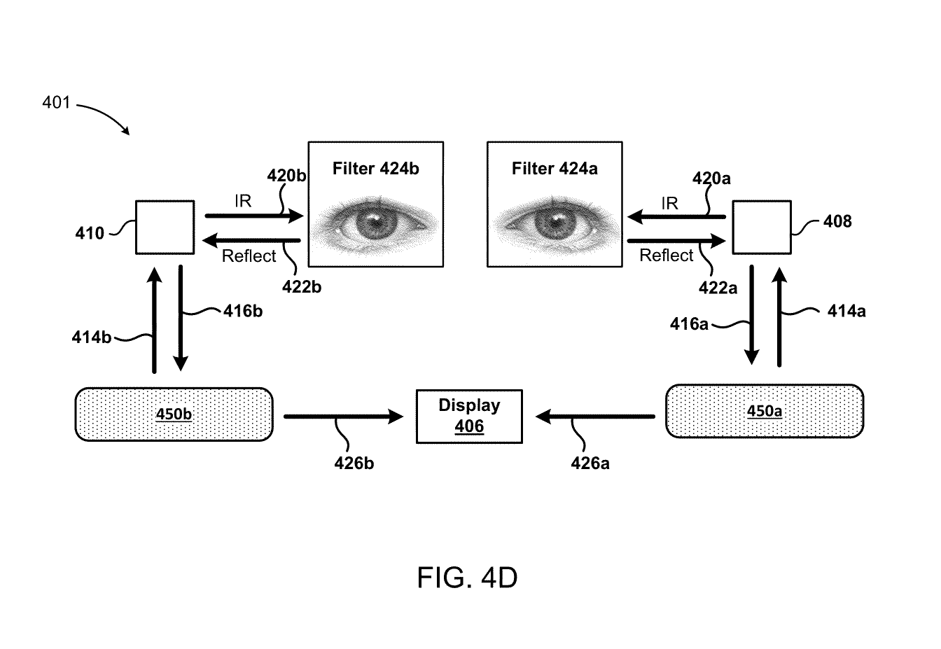

FIG. 4A illustrates an exemplary wearable display device with adaptive optics. FIG. 4B-4C illustrate side views of an exemplary wearable display device with adaptive optics. Here, wearable display device 400 includes frame 402, lenses 404, display 406, delivery optics 408-410, light projection signals 414a-414b, light reflection signal 416a-416b, and display systems 450a-450b. Like-numbered and named elements may describe the same or substantially similar elements as those shown in other descriptions. In some examples, an object may be seen through lenses 404 (e.g., person 412, or the like). In some examples, delivery optics 408-410, display systems 450a-450b and display 406, together may form an adaptive optics system configured to dynamically and automatically (i.e., without manual manipulation by a user) focus an image presented on display 406 to any user, for example, with an eye or pair of eyes focused on an object in an environment seen through lenses 404, and/or with myopia or hyperopia. Various embodiments of adaptive optics systems are described in co-pending U.S. patent application Ser. No. 14/183,463 (Attorney Docket No. ALI-331) and Ser. No. 14/183,472 (Attorney Docket No. ALI-358), both filed Feb. 18, 2014, all of which are herein incorporated by reference in their entirety for all purposes. In some examples, delivery optics 408-410 may optically couple light or images (e.g., using IR, LED, or the like), such as a light or image provided by light projecting signals 414a-414b, with a part of an eye, for example, a retina. In some examples, delivery optics 408-410 also may be configured to receive reflected light (i.e., reflected off of a retina, back through a lens and pupil of an eye) with display systems 450a-450b, for example using light reflection signals 416a-416b. In some examples, display systems 450a-450b may be configured to determine a transfer function representing an optical distortion associated with an eye from which reflection signals 416a-416b are received, which may then be applied to a projected image to be presented on display 406. In some examples, display systems 450a-450b may include optics for projecting or otherwise optically coupling images from display 406 to an eye. In some examples, display systems 450a-450b also may include an image capture device (not shown), and a communication system (not shown) configured to transmit and receive one or more signals (e.g., signals 414a-414b, 416a-416b, 480a-480b, and the like) to and from delivery optics 408-410, a network, or other devices. In still other examples, the quantity, type, function, structure, and configuration of the elements shown may be varied and are not limited to the examples provided.

FIG. 4D depicts a diagram of an adaptive optics system. Here, system 401 includes display 406, delivery optics 408-410, light projection signals 414a-414b, light reflection signal 416a-416b, image data 426a-426b, and display systems 450a-450b. Like-numbered and named elements may describe the same or substantially similar elements as those shown in other descriptions. In some examples, delivery optics 408-410 may deliver optical light signals 420a-420b, respectively, to a user's eyes. In some examples, optical light signal 420a may be associated with light projection signal 414a, and optical light signal 420b may be associated with light projection signal 414b. In some examples, a user's eyes may function as filters 424a-424b, and reflect back reflected light signals 422a-422b. In some examples, light reflection signals 416a-416b may be associated with reflected light signals 422a-422b, respectively, and provide display systems 450a-450b with filter data associated with a transfer function configured to be applied, or otherwise used, to generate image data 426a-426b providing an optically (pre-)distorted image or text to be presented on display 406. In some examples, filter 424a may provide filter data associated with a different transfer function than other filter data provided by filter 424b (i.e., where one eye has a different prescription, shape, or other characteristic, than another eye). In some examples, application of said transfer function may be configured to generate image data 426a-426b to provide an in focus image on display 406, without regard to a user's eye shape, condition, or where a user's eye(s) may be focused (i.e., a pre-distorted image that is in focus for a particular eye). In some example, a transfer function associated with an eye (i.e., filters 424a-424b) may be used as an identification of a user. In still other examples, the quantity, type, function, structure, and configuration of the elements shown may be varied and are not limited to the examples provided.

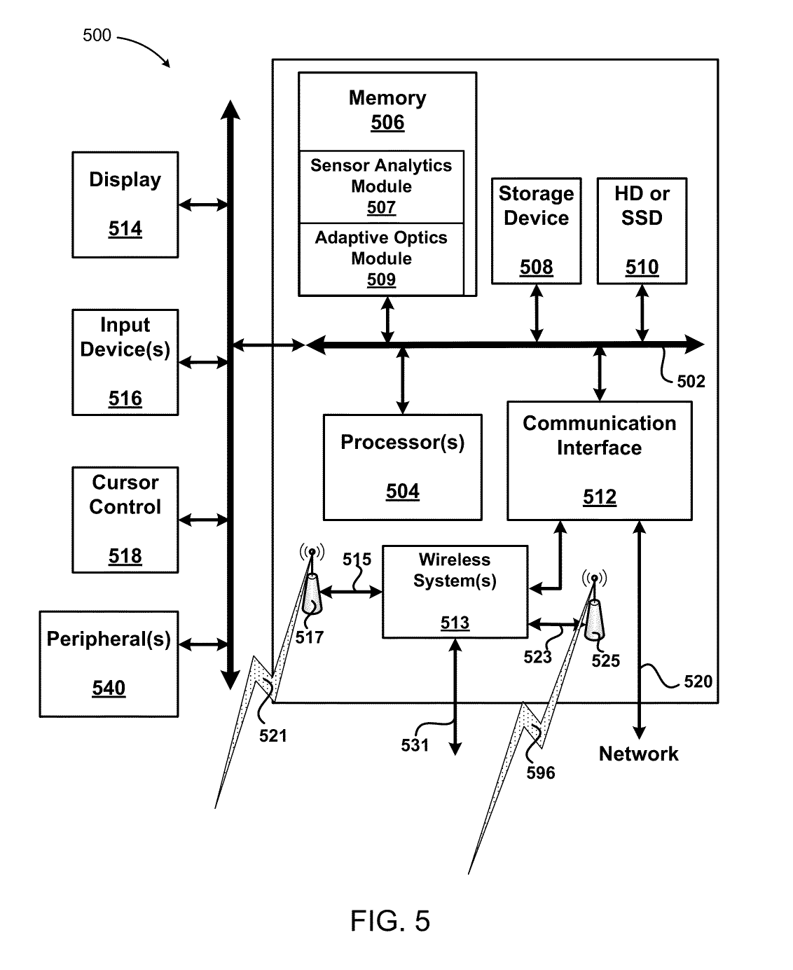

FIG. 5 depicts an exemplary computer system 500 suitable for use in the systems, methods, and apparatus described herein that include wearable display devices 100, 400, or the like. In some examples, computer system 500 may be used to implement circuitry, computer programs, applications (e.g., APP's), configurations (e.g., CFG's), methods, processes, or other hardware and/or software to implement techniques described herein. Computer system 500 includes a bus 502 or other communication mechanism for communicating information, which interconnects subsystems and devices, such as one or more processors 504, system memory 506 (e.g., RAM, SRAM, DRAM, Flash), storage device 508 (e.g., Flash Memory, ROM), disk drive 510 (e.g., magnetic, optical, solid state), communication interface 512 (e.g., modem, Ethernet, one or more varieties of IEEE 802.11, WiFi, WiMAX, WiFi Direct, Bluetooth, Bluetooth Low Energy, NFC, Ad Hoc WiFi, HackRF, USB-powered software-defined radio (SDR), WAN or other), display 514 (e.g., CRT, LCD, OLED, touch screen), one or more input devices 516 (e.g., keyboard, stylus, touch screen display), cursor control 518 (e.g., mouse, trackball, stylus), one or more peripherals 540. Some of the elements depicted in computer system 500 may be optional, such as elements 514-518 and 540, for example and computer system 500 need not include all of the elements depicted.

According to some examples, computer system 500 performs specific operations by processor 504 executing one or more sequences of one or more instructions stored in system memory 506. Such instructions may be read into system memory 506 from another non-transitory computer readable medium, such as storage device 508 or disk drive 510 (e.g., a HD or SSD). In some examples, system memory 506 may include sensor analytics module 507 configured to provide instructions for analyzing sensor data to derive location, physiological, environmental, and other secondary data, as described herein. In some examples, system memory 506 also may include adaptive optics module 509 configured to provide instructions for dynamically and automatically focusing an image for presentation on a display (e.g., displays 106, 204, 308, 406, as described herein, and the like). In some examples, circuitry may be used in place of or in combination with software instructions for implementation. The term “non-transitory computer readable medium” refers to any tangible medium that participates in providing instructions to processor 504 for execution. Such a medium may take many forms, including but not limited to, non-volatile media and volatile media. Non-volatile media includes, for example, Flash Memory, optical, magnetic, or solid state disks, such as disk drive 510. Volatile media includes dynamic memory (e.g., DRAM), such as system memory 506. Common forms of non-transitory computer readable media includes, for example, floppy disk, flexible disk, hard disk, Flash Memory, SSD, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 502 for transmitting a computer data signal. In some examples, execution of the sequences of instructions may be performed by a single computer system 500. According to some examples, two or more computer systems 500 coupled by communication link 520 (e.g., LAN, Ethernet, PSTN, wireless network, WiFi, WiMAX, Bluetooth (BT), NFC, Ad Hoc WiFi, HackRF, USB-powered software-defined radio (SDR), or other) may perform the sequence of instructions in coordination with one another. Computer system 500 may transmit and receive messages, data, and instructions, including programs, (e.g., application code), through communication link 520 and communication interface 512. Received program code may be executed by processor 504 as it is received, and/or stored in a drive unit 510 (e.g., a SSD or HD) or other non-volatile storage for later execution. Computer system 500 may optionally include one or more wireless systems 513 in communication with the communication interface 512 and coupled (signals 515 and 523) with antennas 517 and 525 for receiving and/or transmitting RF signals 521 and 596, such as from a WiFi network, BT radio, or other wireless network and/or wireless devices, devices 206, 212, 214, 400, for example. Examples of wireless devices include but are not limited to: a data capable strap band, wristband, wristwatch, digital watch, or wireless activity monitoring and reporting device; a smartphone; cellular phone; tablet; tablet computer; pad device (e.g., an iPad); touch screen device; touch screen computer; laptop computer; personal computer; server; personal digital assistant (PDA); portable gaming device; a mobile electronic device; and a wireless media device, just to name a few. Computer system 500 in part or whole may be used to implement one or more systems, devices, or methods that communicate with devices 100 and 400 via RF signals (e.g., 596) or a hard wired connection (e.g., data port). For example, a radio (e.g., a RF receiver) in wireless system(s) 513 may receive transmitted RF signals (e.g., 596 or other RF signals) from device 100 that include one or more datum (e.g., sensor system information, content, data, or other). Computer system 500 in part or whole may be used to implement a remote server or other compute engine in communication with systems, devices, or method for use with the device 100 or other devices as described herein. Computer system 500 in part or whole may be included in a portable device such as a wearable display (e.g., wearable display 100) smartphone, media device, wireless client device, tablet, or pad, for example.

As hardware and/or firmware, the structures and techniques described herein can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, intelligent communication module 512, including one or more components, can be implemented in one or more computing devices that include one or more circuits. Thus, at least one of the elements in FIGS. 1-4 can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

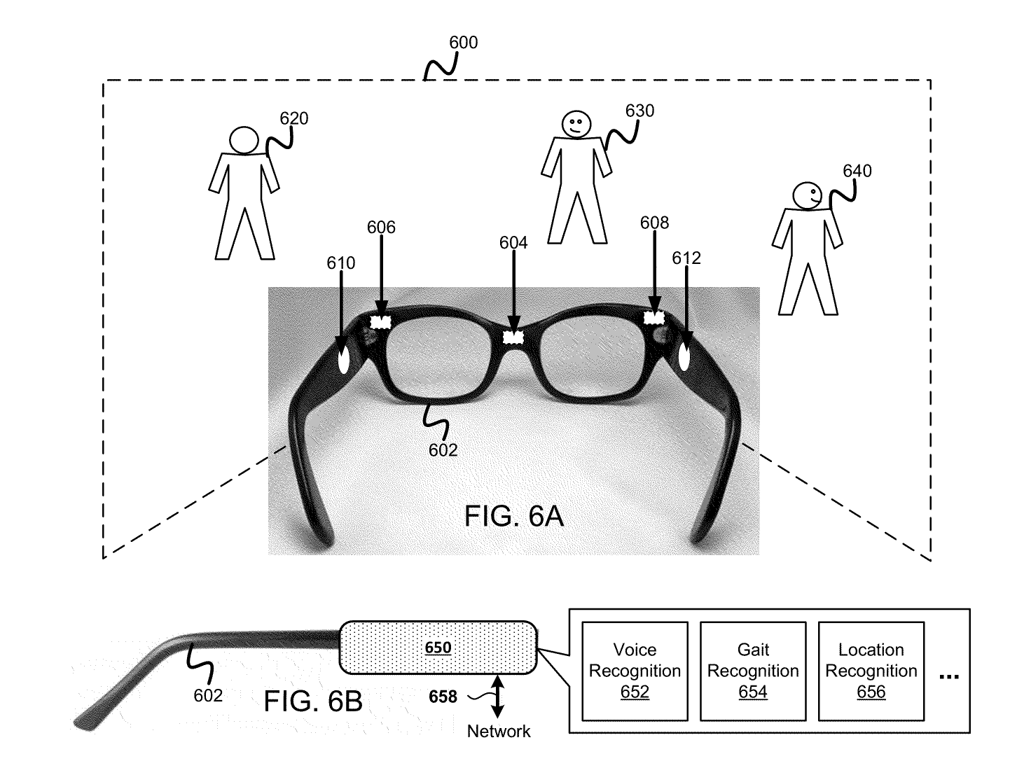

FIG. 6A depicts an exemplary wearable display device having a set of sensors in an environment including objects. Here, wearable sensor device 602 may be used to see objects in environment 600, including persons 620, 630 and 640, and to capture sensor data about environment 600 and persons 620, 630 and 640, using sensors 604-612. In some examples, one or more of sensors 604-612 may be configured to capture sensor data associated with one or more of persons 620, 630 and 640 (i.e., an image of person 630's face for use in a facial recognition algorithm, a video indicating directionality, gait, or motion fingerprint of persons 620, 630 and 640, audio data associated with a voice, and the like). In some examples, one or more of sensors 604-612 may be configured to capture additional sensor data associated with environment 600 (i.e., one or more images of various aspects of environment 600for use in identifying a location or generating location data related to climate, type of setting, nearby businesses or landmarks, a temperature reading, an ambient light reading, acoustic or audio data, and the like). In some examples, one or more of sensors 604-612 may be configured to detect IR radiation (i.e., near IR radiation) from an object (e.g., persons 620, 630, 640, or the like). Thus, sensors 604-612 may include one or more physiological sensors (e.g., for detecting motion, temperature, bioimpedance, chemical composition, skin images, near IR, light absorption and reflection of eyes and skin, outgassing, acoustics, images, and the like), and one or more environmental sensors (e.g., for detecting ambient temperature, gas composition, ambient light, air pressure, wind, ambient sound or acoustics, images, and the like), as described herein. In some examples, various types of secondary data may be derived from sensor data provided by sensors 604-612, using a sensor analytics module (e.g., sensor analytics module 650 in FIG. 6B) as described herein. In still other examples, the quantity, type, function, structure, and configuration of the elements shown may be varied and are not limited to the examples provided.

FIG. 6B depicts a side-view of an exemplary wearable display device having a sensor analytics module. Here, wearable sensor device 602 may include sensor analytics module 650 configured to derive secondary data associated with physiology and environment using voice recognition algorithm 652, gait recognition algorithm 654, location recognition algorithm 656, as well as other algorithms described herein (e.g., a facial recognition algorithm, a social database mining algorithm, an intelligent contextual information provisioning algorithm, or the like). For example, sensor analytics module 650 may be configured to derive gait or motion fingerprint data using video data from one or more of sensors 604-612. Techniques associated with deriving motion fingerprint data using a sensor device are described in U.S. patent application Ser. No. 13/181,498 (Attorney Docket No. ALI-018) and Ser. No. 13/181,513 (Attorney Docket No. ALI-019), both filed Jul. 12, 2011, all of which are incorporated by reference herein in their entirety for all purposes. In another example, sensor analytics module 650 may be configured to derive facial recognition data using image or video data from one or more of sensors 604-612. In still another example, sensor analytics module 650 may be configured to derive ambient data (e.g., providing information regarding ambient light, temperature, air pressure, precipitation, and other environmental characteristics) using light, image, or video data from one or more of sensors 604-612. In yet another example, sensor analytics module 650 may be configured to derive location data using image or video data from one or more of sensors 604-612. In still other examples, sensor analytics module 650 may be configured to derive physiological data, voice recognition data, and other types of secondary data, using near IR radiation data, image data, audio data, video data, and the like, from one or more of sensors 604-612. In some examples, sensor analytics module 650 may be configured to access stored acoustic signature data associated with one or more of persons 620, 630 and 640, and environment 600, for identification (i.e., of a person or location) purposes. In some examples, sensor analytics module 650 may be configured to communicate with a network using signal 658, for example, to access remote data (i.e., social data, climate data, other third party data, and the like).

In some examples, sensor analytics module 650 may be configured to derive sensor analytics data associated with an identity, a social graph, an environment, or the like, using sensor data from one or more of sensors 604-612. For example, sensor analytics module 650 may be configured to derive identifying information regarding persons 620, 630 and 640 using different algorithms and processes based on sensor data regardless of an orientation of persons 620, 630 and 640. For example, where person 620 is facing away from wearable sensor device 602, sensor analytics module 650 may be configured to use gait recognition module 654 to derive identifying information about person 620 using video and/or image data associated with person 620 from one or more of sensors 604-612. In another example, where person 630 is facing wearable sensor device 602, sensor analytics module 650 may be configured to use a facial recognition algorithm, as described herein, as well as voice recognition algorithm 652, to derive identifying information about person 630 using video and/or image data, and acoustic data, from one or more of sensors 604-612. In still another example, where person 640 is facing to the side, sensor analytics module 650 may be configured to use gait recognition algorithm 654 and voice recognition algorithm 652 to derive identifying information about person 640 using video and/or image data, and acoustic data, from one or more of sensors 604-612. In some examples, sensor analytics module 650 may be configured to derive location information about environment 600 using location recognition 656. In other examples, sensor analytics module 650 may be configured to access remote data (i.e., available by a wired or wireless network), including social data, applications configured to run additional algorithms, and the like, using signal 658. In still other examples, the quantity, type, function, structure, and configuration of the elements shown may be varied and are not limited to the examples provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A device, comprising:
a frame configured to be worn;
a display coupled to the frame, the display configured to provide an image in a field of vision;
a sensor configured to capture sensor data;
a secondary sensor configured to capture environmental data;
a sensor analytics module configured to process the sensor data and the environmental data to generate sensor analytics data; and
a communication facility configured to send sensor analytics data to another device and to receive remote data.

2. The device of claim 1, wherein the sensor analytics module is configured to derive gait data using video data from the sensor.

3. The device of claim 1, wherein the sensor analytics module is configured to derive facial recognition data using image data from the sensor.

4. The device of claim 1, wherein the sensor analytics module is configured to derive ambient data using light data from the sensor.

5. The device of claim 1, wherein the sensor analytics module is configured to derive location data using image data from the sensor.

6. The device of claim 1, wherein the sensor analytics module is configured to derive physiological data using near infrared radiation data from the sensor.

7. The device of claim 1, wherein the sensor analytics module is configured to derive physiological data using image data from the sensor.

8. The device of claim 1, wherein the sensor analytics module is configured to derive voice recognition data using audio data from the sensor.

9. The device of claim 1, wherein the sensor analytics module is configured to derive location data associated with an acoustic signature using audio data from the sensor.

10. The device of claim 1, wherein the remote data is received from a remote device configured to access identity data from a social network.

11. The device of claim 1, wherein the remote data is received from a remote device configured to run a social database mining algorithm.

12. The device of claim 1, wherein the remote data comprises social data to be presented using the display.

13. The device of claim 1, wherein the display is configured to operate in at least two modes comprising a non-display mode and a display mode.

14. A device, comprising:
a frame configured to be worn;
a display coupled to the frame, the display configured to provide an image in a field of vision;
a sensor configured to capture sensor data;
a secondary sensor configured to capture environmental data;
a sensor analytics module configured to process the sensor data and the environmental data to generate sensor analytics data;
a communication facility configured to send sensor analytics data to another device and to receive remote data; and
an adaptive optics module configured to determine an optical distortion to be applied to the image.

15. The device of claim 14, wherein the optical distortion is configured to bring the image into focus for a myopic eye.

16. The device of claim 14, wherein the optical distortion is configured to bring the image into focus for a hyperopic eye.

17. The device of claim 14, wherein the optical distortion is configured to bring the image into focus for an eye while an ambient image also is in focus for the eye.
